(19) United States
(12) Patent Application Publication
(10) Pub. No.: US 2026/0341049 A1
(43) Pub. Date: Oct. 29, 2026

(54) SHELF LABEL ESTIMATION DEVICE, SHELF LABEL ESTIMATION METHOD, AND RECORDING MEDIUM

(71) Applicant: NEC Corporation, Tokyo (JP)

(72) Inventor: Manabu NAKANOYA, Tokyo (JP)

(73) Assignee: NEC Corporation, Tokyo (JP)

(21) Appl. No.: 19/646,754

(22) Filed: Apr. 14, 2026

(30) Foreign Application Priority Data
Apr. 25, 2025 (JP) 2025-073163

(51) Int. Cl. G06V 20/68; G06T 7/13; G06V 10/25

(52) U.S. Cl. CPC G06V 20/68; G06T 7/13; G06V 10/25; G06V 2201/07

(57) ABSTRACT

A shelf label estimation device includes: at least one memory configured to store instructions; and at least one processor configured to execute the instructions to perform object recognition of shelf label candidates from an image in which an article shelf is captured; extract boundary lines of the shelf label for each of the recognized shelf label candidates; extract basic information of the shelf label for each region sandwiched by the boundary lines; and estimate a single shelf label region for each of the regions by using a weighted average score of an extraction result of the basic information of the shelf label.

### CROSS-REFERENCE TO RELATED APPLICATION

This application is based upon and claims the benefit of priority from Japanese Patent Application No. 2025-073163, filed on Apr. 25, 2025, the disclosure of which is incorporated herein in its entirety by reference.

### TECHNICAL FIELD

The present disclosure relates to a shelf label estimation device and the like.

### BACKGROUND ART

There is a technology of estimating a shelf label by object recognition from an image in which a shelf is captured. WO 2019/087792 A1 describes a technology for detecting a position of a shelf label arranged on a display shelf by video recognition.

### SUMMARY

In a case where the shelf label is subjected to object recognition of the shelf label from the captured image of the shelf, recognition accuracy of the shelf label may still be low.

An example of an object of the present disclosure is to provide a shelf label estimation device and the like that improves estimation accuracy of a shelf label region.

A shelf label estimation device according to an aspect of the present disclosure includes

a recognition unit for performing object recognition of shelf label candidates from an image in which an article shelf is captured,

a first extraction unit for extracting boundary lines of the shelf label for each of the recognized shelf label candidates,

a second extraction unit for extracting basic information of the shelf label for each region sandwiched by the extracted boundary lines, and

an estimation unit for estimating a single shelf label region for each of the regions by using a weighted average score of an extraction result of the basic information of the shelf label.

A shelf label estimation method according to an aspect of the present disclosure causes a computer to execute processing of

performing object recognition of shelf label candidates from an image in which an article shelf is captured,

extracting boundary lines of the shelf label for each of the recognized shelf label candidates,

extracting basic information of the shelf label for each region sandwiched by the extracted boundary lines, and

estimating a single shelf label region for each of the regions by using a weighted average score of an extraction result of the basic information of the shelf label.

A program according to one aspect of the present disclosure causes a computer to execute processing of

performing object recognition of shelf label candidates from an image in which an article shelf is captured,

extracting boundary lines of the shelf label for each of the recognized shelf label candidates,

extracting basic information of the shelf label for each region sandwiched by the extracted boundary lines, and

estimating a single shelf label region for each of the regions by using a weighted average score of an extraction result of the basic information of the shelf label.

The program may be stored in a non-transitory computer-readable recording medium.

### BRIEF DESCRIPTION OF THE DRAWINGS

FIG. 1 is a block diagram illustrating a configuration example of a shelf label estimation device;

FIG. 2 is an explanatory diagram illustrating an example in which four shelf labels are recognized as one shelf label candidate;

FIG. 3 is an explanatory diagram illustrating an example of a boundary region;

FIG. 4 is an explanatory diagram illustrating an example in which shelf label candidates are recognized;

FIG. 5 is an explanatory diagram illustrating an example of a boundary region;

FIG. 6 is a flowchart illustrating an operation example of the shelf label estimation device;

FIG. 7 is a block diagram illustrating another configuration example of the shelf label estimation device; and

FIG. 8 is an explanatory diagram illustrating a hardware configuration example of a computer.

### EXAMPLE EMBODIMENT

Hereinafter, example embodiments of a shelf label estimation device, a shelf label estimation method, a program, and a non-transitory recording medium recording the program according to the present disclosure will be described in detail with reference to the drawings. The example embodiments do not limit the disclosed technology.

In an example embodiment, an example of a function of a shelf label estimation device will be described in detail with reference to the drawings.

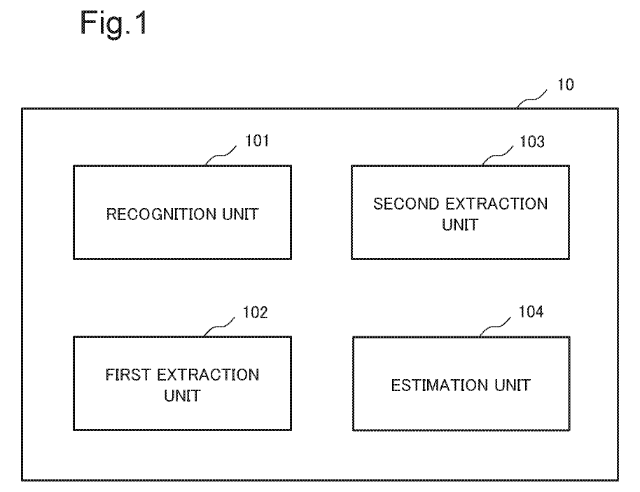

FIG. 1 is a block diagram illustrating a configuration example of a shelf label estimation device. A shelf label estimation device 10 includes a recognition unit 101, a first extraction unit 102, a second extraction unit 103, and an estimation unit 104. Each functional unit appropriately stores an intermediate result or a result in a storage device or the like, or reads necessary information.

The recognition unit 101 recognizes shelf label candidates as objects from the image obtained by imaging the article shelf.

The article shelf may be constituted by, for example, one or more stages. Here, the article shelf includes a shelf board, and a shelf label of the article is attached to the shelf board. For example, the facility in which the article shelf is installed is not particularly limited to a store, a warehouse, or the like. When the facility is a store, the article may be referred to as a product, and the article shelf may be referred to as a product shelf.

For example, the imaging device that images the article shelf may be a fixedly arranged device, a device mounted on a moving body or the like, or a device provided in a device portable by the user, such as a smartphone, a tablet-type device, or a wearable device.

Here, the recognition unit 101 detects a rectangle of the shelf label as the object recognition. Therefore, in the object recognition, since rough shelf label candidates are estimated, accuracy may be low. For example, in a case where a plurality of shelf labels are approaching or partially overlap, there is a case where the shelf labels are recognized as one shelf label. Therefore, the shelf label estimation device 10 extracts boundary lines for each of the shelf label candidates, and estimates whether it is a region of a shelf label based on basic information of the shelf label for each region sandwiched by the boundary lines.

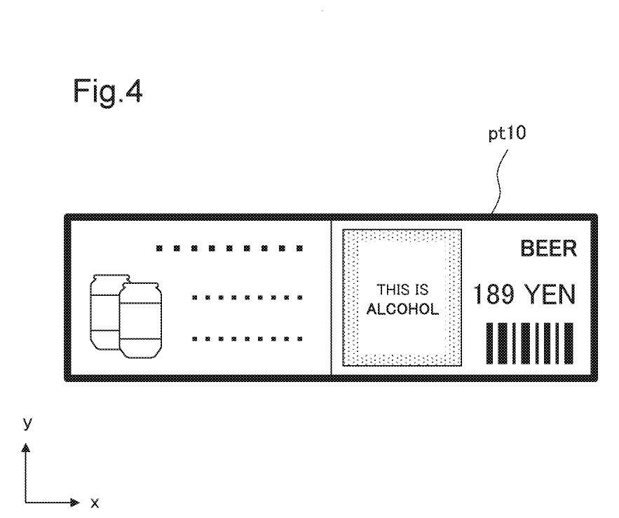

The first extraction unit 102 extracts boundary lines of a shelf label for each of the recognized shelf label candidates. The boundary line of the shelf label is a boundary line in the lateral direction of the shelf. Here, a boundary line in a direction substantially parallel to the shelf board may not be an extraction target. Specifically, for example, the first extraction unit 102 extracts boundary lines of a shelf label by image recognition for each of the shelf label candidates. The first extraction unit 102 extracts the boundary lines by performing the line segment detection according to the change value of the pixel of each pixel. For the line segment detection, an existing technology may be used, and thus, detailed description thereof is omitted. For example, a line that is originally present in one shelf label may be determined not to be detected. For example, as illustrated in FIG. 4 to be described later, sentences in some shelf labels are highlighted in different colors. If the pattern of the design of the shelf label and the like are determined in advance, the first extraction unit 102 can more accurately extract the boundary lines by line segment detection. Accordingly, even in a case where a plurality of shelf labels are recognized as one shelf label candidate by object recognition, the first extraction unit 102 can extract a region estimated to be a shelf label by extracting boundary lines by line segment detection.

The second extraction unit 103 extracts the basic information of the shelf label for each region sandwiched by the extracted boundary lines for the shelf label candidates. The region sandwiched by the boundary lines extracted for the shelf label candidates is a region sandwiched by boundary lines adjacent in the lateral direction of the shelf. The region of the shelf label candidate is divided into a plurality of regions by boundary lines. For example, in a case where three boundary lines are extracted for the shelf label candidates, the number of regions sandwiched between the boundary lines is two. That is, the region of the shelf label candidate is divided into two regions by boundary lines.

The basic information of the shelf label includes a price, an article name, a code, and the like. The code may be, for example, a one-dimensional code such as a barcode, or a two-dimensional code. The basic information of the shelf label may be, for example, discount information or the like. When the facility is a store, items of basic information on a general shelf label include a price, an article name (product name), and a barcode. The barcode may include, for example, link information that enables access to a site or the like introducing a product when a customer operates a terminal to read the barcode. Alternatively, the barcode may be capable of acquiring information such as the stock quantity of the store when the store clerk operates the terminal to read the barcode. Here, an example of the basic information of the shelf label for the product of the store has been described, but the basic information of the shelf label may be appropriately determined according to the use of the shelf label depending on the facility.

The second extraction unit 103 extracts basic information by character recognition and image recognition for each boundary region. For example, in character recognition, the second extraction unit 103 extracts a price and an article name by character recognition. Since an existing technology such as optical character recognition (OCR) may be used as the character recognition, detailed description thereof is omitted. For example, in image recognition, the second extraction unit 103 extracts a code by image recognition. Since the image recognition of the code only needs to use the existing technology, detailed description thereof is omitted.

The estimation unit 104 estimates a single shelf label region by using a weighted average score of an extraction result of the basic information of the shelf label for each region sandwiched by boundary lines extracted for the shelf label candidates. Here, a region sandwiched by the boundary lines is referred to as a boundary region. Various processing results by the estimation unit 104 are appropriately stored in a storage device or the like.

First, for example, the estimation unit 104 calculates a weighted average score of the extraction result of the basic information of the shelf label for each boundary region. A specific calculation method will be described. Specifically, for example, the estimation unit 104 may calculate the weighted average score based on the number of items of the extracted basic information of the shelf label and the recognition certainty factor of each item. For example, the score may be higher as the number of items of the extracted basic information of the shelf label is larger. For example, the estimation unit 104 may add a weight to the recognition certainty factor of the item of the basic information to calculate the weighted average score. For example, the closer the combination of items of the recognized basic information is to a pattern of a typical shelf label, the higher the score is. As described above, when the facility is a store, items of basic information on a general shelf label include a price, an article name (product name), and a barcode. For example, in a case where three items of a price, an article name, and a barcode are recognized with high certainty, the price and the article name are recognized, and the weighted average score is higher than that in a case where the barcode is not recognized. The estimation unit 104 may calculate the weighted average score so that the weight of the price, the article name, and the barcode becomes higher than the discount information. Since the basic information of the shelf label varies depending on the store and the industry type, it is only required to appropriately set which item has a higher weight.

Then, the estimation unit 104 estimates a single shelf label region for each boundary region by using the weighted average score. For example, the estimation unit 104 estimates, for each boundary region, whether the boundary region is a single shelf label region based on whether the weighted average score is equal to or more than a first threshold. The first threshold is a lower limit value of a score at which it is estimated that one shelf label has necessary information, and may be appropriately determined according to a method of calculating a weighted average score. For example, if the weighted average score calculated for the boundary region is equal to or more than the first threshold, the estimation unit 104 estimates that the boundary region is a single shelf label region. For example, if the weighted average score calculated for the boundary region is less than the first threshold, the estimation unit 104 estimates that the boundary region does not satisfy a single shelf label region.

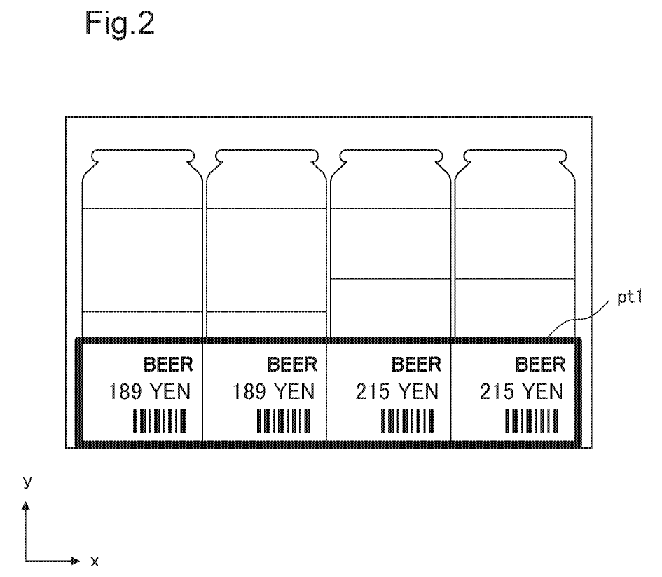

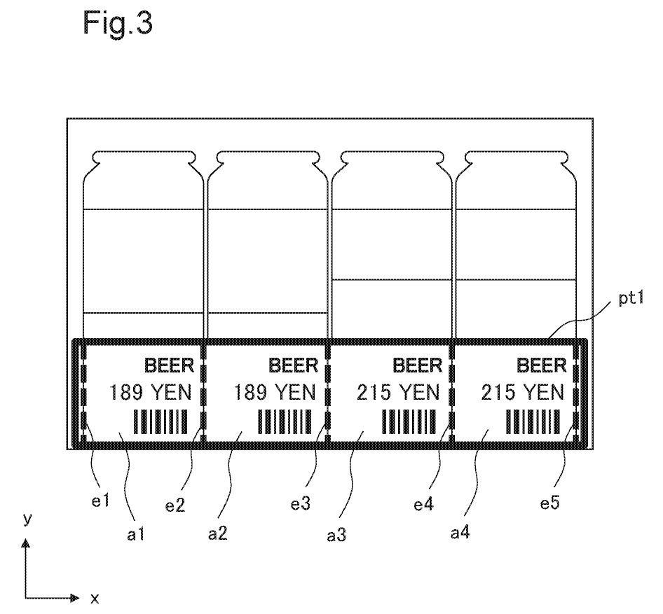

Here, a detailed example will be described with reference to FIGS. 2 and 3.

FIG. 2 is an explanatory diagram illustrating an example in which four shelf labels are recognized as one shelf label candidate. In the object recognition, in a case where a plurality of shelf labels are arranged in an overlapping manner, the object is recognized as one shelf label in some cases. In FIG. 2, four shelf labels are object-recognized as one shelf label candidate pt1. As described above, in a case where a plurality of shelf labels are approaching or overlapping, there is a case where the shelf labels are erroneously recognized as one shelf label candidate.

In FIG. 2, the lateral direction of the shelf, which is the direction of the shelf board, is defined as the x axis, and the height direction of the shelf is defined as the y axis. In the following drawings, the x axis and the y axis are similarly defined.

FIG. 3 is an explanatory diagram illustrating an example of a boundary region. In FIG. 3, since five boundary lines e1 to e5 are extracted for the shelf label candidate pt1, the regions sandwiched by the boundary lines are boundary regions a1 to a4.

Here, the boundary regions a1 to a4 each include a product name, a price, and a barcode. For example, since the weighted average score calculated for each of the boundary regions a1 to a4 is equal to or more than the first threshold, the estimation unit 104 estimates that each of the boundary regions a1 to a4 is a single shelf label region. The estimation result is appropriately stored in a storage device or the like.

It is assumed that the boundary lines of the shelf labels are not accurately extracted in a case where the shelf labels overlap each other. In such a case, a plurality of shelf label regions may be included in a region sandwiched by boundary lines. For example, the estimation unit 104 may estimate, for each boundary region, whether the boundary region is a single shelf label region or whether the boundary region includes a plurality of shelf label regions by using the weighted average score.

For each boundary region, the estimation unit 104 estimates that the region is a single shelf label region when the weighted average score is equal to or greater than the first threshold and less than the second threshold. The second threshold is an upper limit value of a score at which it is estimated that one shelf label has necessary information, and may be appropriately determined according to a method of calculating a weighted average score. For each boundary region, if the weighted average score is equal to or more than the second threshold, the estimation unit 104 estimates that the boundary region includes a plurality of shelf label regions.

For each boundary region, if the weighted average score is less than the first threshold, the estimation unit 104 estimates that the boundary region does not satisfy a single shelf label region. Then, when it is estimated that the boundary region is not a single shelf label region by using the weighted average score, the estimation unit 104 may delete at least one of the boundary lines sandwiching the boundary region. The boundary line to be deleted may be determined in advance. For example, the boundary line to be deleted may be determined in advance by a relative positional relationship between the boundary lines. For example, there is a case where a facility is operated according to a predetermined rule such as giving a label on the left side of a shelf label, the label describing information related to a product displayed on the shelf label, to the shelf board. In such a case, the boundary line to be deleted is the boundary line on the right side of the boundary region. For example, in a case where the horizontal direction is defined as the x axis in the shelf, the right direction of the shelf board is the plus direction of the x axis and the left direction of the shelf board is the direction approaching the origin of the x axis, so that the estimation unit 104 deletes the boundary line in the plus direction in the boundary region.

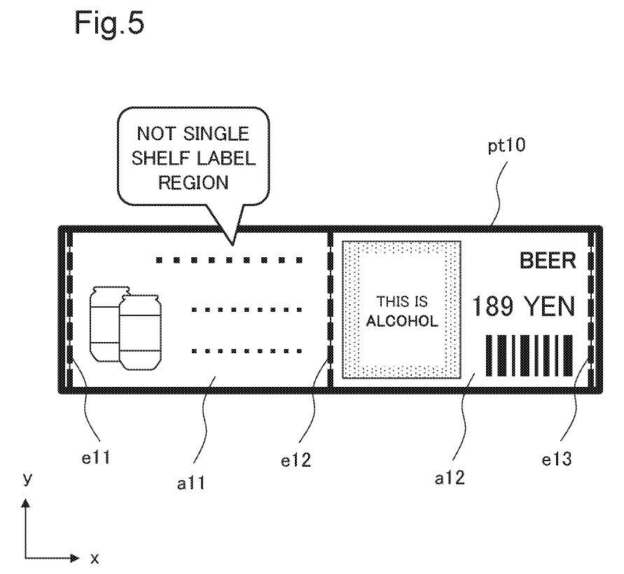

Here, an example in which the boundary region does not satisfy a single shelf label region will be described with reference to FIGS. 4 and 5.

FIG. 4 is an explanatory diagram illustrating an example in which a shelf label candidate is recognized. In FIG. 4, a shelf label and a product inquiry sheet are installed on a shelf board. In FIG. 4, a region including a shelf label and a product inquiry sheet is recognized by the recognition unit 101 as a shelf label candidate pt10.

FIG. 5 is an explanatory diagram illustrating an example of a boundary region. In FIG. 5, with respect to the shelf label candidate pt10, since three boundary lines e11 to e13 are extracted by the first extraction unit 102, a region sandwiched by the boundary lines includes a boundary region a11 and a boundary region a12.

Here, the boundary region a12 includes one product name, one price, and one barcode. For example, since the weighted average score calculated for the boundary region a12 is equal to or more than the first threshold and less than the second threshold, the estimation unit 104 estimates that the boundary region a12 is a single shelf label region.

The boundary region a11 does not include a product name, a price, and a barcode. Therefore, for example, since the weighted average score calculated for the boundary region a11 is less than the first threshold, the estimation unit 104 estimates that the boundary region a11 does not satisfy a single shelf label region. In a case where the shelf label region does not satisfy a single shelf label region, it is assumed that a boundary line in a positive direction in the x-axis direction as illustrated in FIG. 5 is determined in advance to be deleted. Therefore, for example, the estimation unit 104 deletes the boundary line e12 for the boundary region a11 of the shelf label candidate pt10. Since the boundary region a12 is estimated as a single shelf label region and the boundary line e12 is deleted, the estimation unit 104 estimates a region sandwiched between the boundary line e11 and the boundary line e13 as a single shelf label region for the shelf label candidate pt10.

The description of the estimation result of the shelf label region is terminated. Here, the estimation result of the shelf label region may be reflected in a database of shelf allocation or the like. For example, in a case where one shelf label is given to one article, the estimation result of the shelf label region may be used for estimating the article section.

### Flowchart

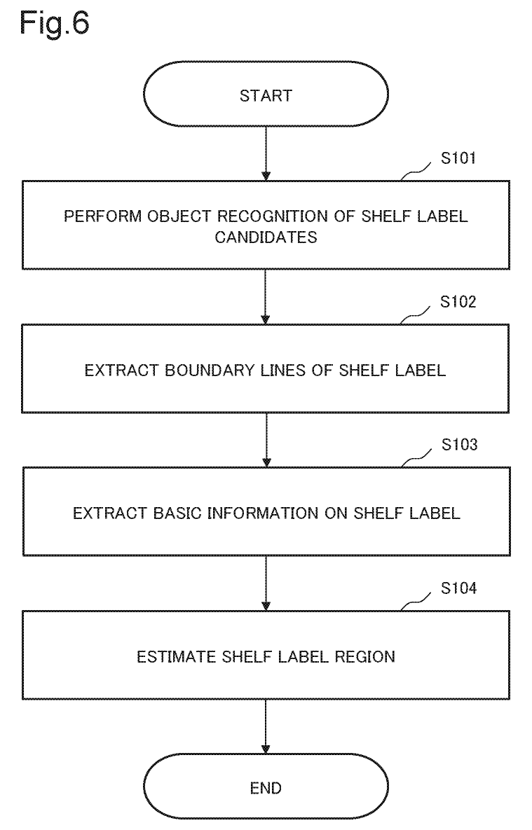

FIG. 6 is a flowchart illustrating an operation example of the shelf label estimation device 10. The recognition unit 101 recognizes shelf label candidates as an object from the image obtained by imaging the article shelf (step S101). The first extraction unit 102 extracts boundary lines of a shelf label for each of the recognized shelf label candidates (step S102).

The second extraction unit 103 extracts the basic information of the shelf label for each region sandwiched by the boundary lines extracted by the first extraction unit 102 (step S103).

The estimation unit 104 estimates a single shelf label region for each region sandwiched by the boundary lines extracted by the first extraction unit 102 using a weighted average score of an extraction result of the basic information of the shelf label (step S104). Then, the shelf label estimation device 10 ends the series of processes illustrated in FIG. 6.

As described above, in the object recognition, since a rough shelf label candidate is estimated, accuracy may be low. For example, in a case where a plurality of shelf labels are approaching or partially overlap, there is a case where the shelf labels are recognized as one shelf label. Therefore, in the first example embodiment, the shelf label estimation device 10 extracts boundary lines for each recognized shelf label candidate. The shelf label estimation device 10 extracts basic information of a shelf label for each region sandwiched by the extracted boundary lines. Then, the shelf label estimation device 10 estimates a single shelf label region using a weighted average score of an extraction result of the basic information of the shelf label for each region sandwiched by the boundary lines. Specifically, for example, if the weighted average score is equal to or more than a first threshold for each region sandwiched by the boundary lines, the shelf label estimation device 10 estimates that the region sandwiched by the boundary lines is a single shelf label region. As a result, it is possible to improve the estimation accuracy of the region of the shelf label.

In a case where it is estimated that the region sandwiched by the boundary lines is not a single shelf label region by using the weighted average score, the shelf label estimation device 10 deletes at least one of the boundary lines sandwiching the region. As a result, when the region sandwiched by the boundary lines does not satisfy a single shelf label region, the region and the adjacent region sandwiched by the boundary lines become one region.

A plurality of shelf labels may be included in a region sandwiched by boundary lines. Therefore, the shelf label estimation device 10 uses the weighted average score for each region sandwiched by the boundary lines to estimate whether the region sandwiched by the boundary lines is a single shelf label region or whether the region sandwiched by the boundary lines includes a plurality of shelf label regions. In a case where the region sandwiched by the boundary lines includes a plurality of shelf label regions, the weighted average score is larger than that in a case where the region is a single shelf label region. Therefore, for each region sandwiched by the boundary lines, the shelf label estimation device 10 estimates that the region sandwiched by the boundary lines is a single shelf label region when the weighted average score is equal to or more than the first threshold and less than the second threshold, and estimates that the region sandwiched by the boundary lines includes a plurality of shelf label regions when the weighted average score is equal to or more than the second threshold. Accordingly, it is possible to improve estimation accuracy of a single shelf label region.

Thus, the description of the example embodiments has ended. The example embodiments are not limited to the examples described above and can be variously changed. Modified examples will be described hereinafter.

### First Modified Example

For example, the estimation result or the like may be notified to a user such as a manager of the facility.

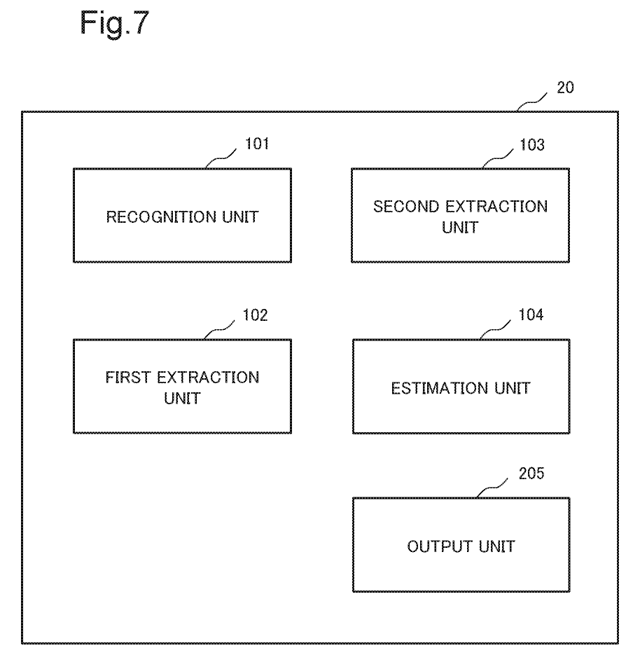

FIG. 7 is a block diagram illustrating another configuration example of the shelf label estimation device. A shelf label estimation device 20 further includes a recognition unit 101, a first extraction unit 102, a second extraction unit 103, an estimation unit 104, and an output unit 205.

The output unit 205 outputs, for example, the estimation result to the terminal of the user. The terminal may be an output destination device to which shelf label estimation device is output, or may be an input source device that inputs information to the shelf label estimation device. For example, in the terminal, an application program capable of outputting information from the shelf label estimation device or transmitting information to the shelf label estimation device may be installed in advance. For example, the terminal may access a site of the shelf label estimation device, which is a website, via a communication network NT. The type of terminal is not particularly limited, and may be a personal computer (PC), a smartphone, a tablet device, or the like. The number of terminals is not particularly limited, and the terminals may be prepared for each user.

An output method by the output unit 205 is not particularly limited, and may be a screen display, voice output, or the like.

The output unit 205 makes a notification when it is estimated that the region sandwiched by the boundary lines includes a plurality of shelf label regions. The notification destination may be a terminal of the user. For example, the notification method is not particularly limited, and examples thereof include push notification and email notification. For example, the output unit 205 may give a notification by superimposing a mark indicating a boundary region and information indicating a plurality of shelf label regions on a captured image and displaying the superimposed image on the terminal. For example, the output unit 205 may notify the terminal of the user that some of the plurality of shelf labels overlap each other. For example, the user can confirm the notification and confirm the estimation result of the shelf label. The user may confirm the notification and confirm the actual status of the shelf label.

### Second Modified Example

In the example embodiment, an example has been described in which the first extraction unit 102 extracts boundary lines of a shelf label for each of the recognized shelf label candidates, and the second extraction unit 103 extracts basic information of the shelf label for each region sandwiched by the boundary lines extracted by the first extraction unit 102. The first extraction unit 102 and the second extraction unit 103 may be the same functional unit, and for example, the second extraction unit 103 may extract boundary lines and basic information of a shelf label for each shelf label candidate. Then, the estimation unit may calculate, for each shelf label candidate, a weighted average score of an extraction result of the basic information of the shelf label for each region sandwiched by the boundary lines. The estimation unit may estimate a single shelf label region by using a weighted average score of an extraction result of basic information of the shelf label for each region sandwiched by boundary lines. In this manner, the order and the like of each processing can be changed as appropriate.

The description of the modified examples is ended. The example embodiments and the modified examples may be combined with each other as appropriate. There is no particular limitation on how the example embodiments are combined with each other. In addition, the example embodiments and the modified examples may be appropriately combined. How the example embodiments and the modified examples are combined is not particularly limited.

The configurations of the shelf label estimation devices 10 and 20 are not particularly limited. For example, the functional units of the shelf label estimation devices 10 and 20 may be implemented by one device. Alternatively, for example, the functional units of the shelf label estimation devices 10 and 20 or databases may be implemented by different devices from each other and may be configured as a system. For example, the functional units of the shelf label estimation devices 10 and 20 may be configured with a plurality of servers and implemented as a distributed system. For example, a system including a database server including databases and a server including the functional units of the shelf label estimation devices 10 and 20 may be implemented. A system including a server including a part of the functional units of the shelf label estimation devices 10 and 20 and a server including another part of the functional units of the shelf label estimation devices 10 and 20 may be implemented. The number of servers is not particularly limited.

The various types of information are exemplary and may further include other information or may not include some of the information.

### Hardware Configuration Example of Computer

Next, a hardware configuration example in a case where each device such as the shelf label estimation devices 10 and 20 and the terminal is implemented by a computer will be described.

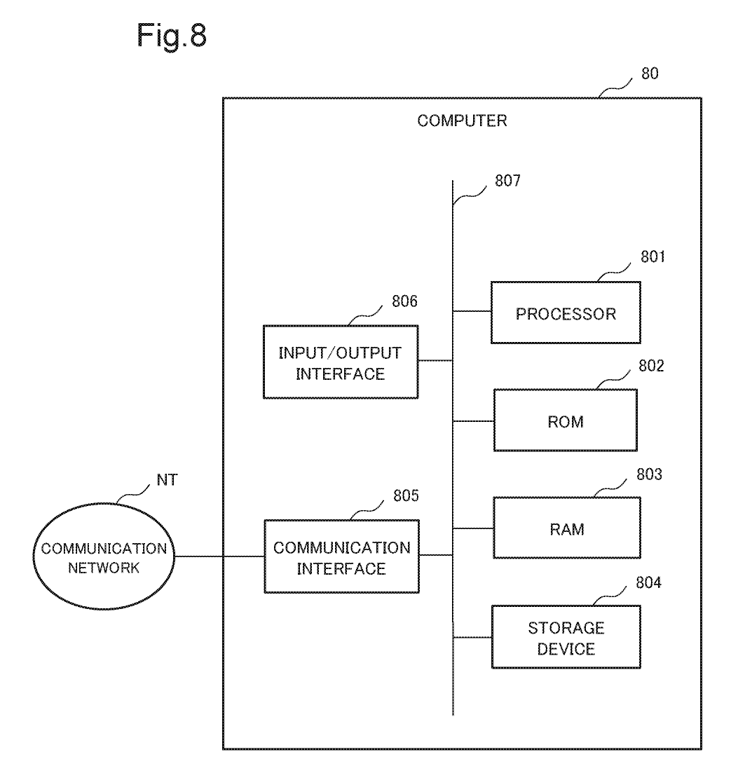

FIG. 8 is an explanatory diagram illustrating a hardware configuration example of a computer. For example, some or all of the devices can also be implemented using any combination of a computer 80 as illustrated in FIG. 8 and a program.

The computer 80 includes, for example, a processor 801, a read only memory (ROM) 802, a random access memory (RAM) 803, and a storage device 804. The computer 80 also includes a communication interface 805 and an input/output interface 806. The constituent members are connected to each other via a bus 807, for example. The number of constituent members is not particularly limited, and the number of constituent members is one or multiple.

The processor 801 controls the entire computer 80. As the processor 801, for example, a central processing unit (CPU), a digital signal processor (DSP), a graphics processing unit (GPU), a physics processing unit (PPU), a tensor processing unit (TPU), a quantum processor, or a combination thereof, or the like can be used and is not particularly limited. The processor 801 may be a single-core processor or a multi-core processor.

The computer 80 includes the ROM 802, the RAM 803, and the storage device 804, for example. Examples of the storage device 804 include a semiconductor memory such as a flash memory, a hard disk drive (HDD), a solid state drive (SSD), and an optical disc. These may be used alone or in combination of two or more. For example, the storage device 804 stores an operating system (OS) program, an application program, a program according to the example embodiments, and the like. Alternatively, the ROM 802 stores an application program, a program according to the example embodiments, and the like. The RAM 803 is used as a work area for the processor 801.

The processor 801 loads a program stored in the storage device 804, the ROM 802, or the like. The processor 801 executes each process coded in the program. The processor 801 may download various programs via the communication network NT. The processor 801 functions as a part or the whole of the computer 80. Based on the program, the processor 801 may execute the processes or instructions in the flowchart illustrated in the drawing.

The communication interface 805 is connected to the communication network NT such as a local area network (LAN) or a wide area network (WAN) through a wireless or wired communication line. The communication network NT may be constituted by a plurality of communication networks NT. As a result, the computer 80 is connected to an external device or an external computer 80 via the communication network NT. The communication interface 805 takes control of an interface between the communication network NT and the inside of the computer 80. The communication interface 805 controls input and output of data from and to the external device or the external computer 80.

The input/output interface 806 is connected to at least one of an input device, an output device, and an input/output device. A method of the connection may be wireless or wired. Examples of the input device include a keyboard, a mouse, and a microphone. Examples of the output device include a display device, a lighting device (such as a lamp), and a sound output device that outputs a sound. Examples of the input/output device include a touch panel display. The input device, the output device, the input/output device, and the like may be built in the computer 80 or may be externally attached to the computer 80. That is, for example, the computer 80 may include an input device such as a keyboard or a mouse. The computer 80 may include an output device such as a display. The computer 80 may include each of an input device, an output device, and an input/output device.

The hardware configuration of the computer 80 is an example. The computer 80 may include some components illustrated in FIG. 8. The computer 80 may include a component other than those illustrated in FIG. 8. For example, the computer 80 may include a drive device. The processor 801 may read a program or data stored in a recording medium mounted on the drive device or the like into the RAM 803. Examples of the non-transitory tangible recording medium include an optical disc, a flexible disk, a magneto-optical disk, and a universal serial bus (USB) memory.

The computer 80 may include various sensors (not illustrated). The types of sensors are not particularly limited. The computer 80 may include an imaging device capable of capturing images and videos.

Thus, the description of the hardware configuration of each device has ended. A method for implementing each device has various modified examples. For example, each device may be implemented by any combination of a computer and a program different for each component. A plurality of components included in each device may be implemented by any one combination of a computer and a program.

Some or all of the components of each device may be implemented by an application specific circuit. Some or all of the components of each device may be implemented by a general-purpose circuit such as a field programmable gate array (FPGA). Some or all of the components of each device may be implemented by a combination of an application specific circuit, a general-purpose circuit, and the like. These circuits each may be a single integrated circuit. Alternatively, these circuits each may be divided into a plurality of integrated circuits. The plurality of integrated circuits may be configured by being connected via a bus or the like.

In a case where some or all of the components of each device are implemented by a plurality of computers, circuits, and the like, the plurality of computers, circuits, and the like may be arranged in a centralized manner or in a distributed manner.

The shelf label estimation method described in each example embodiment may be implemented by causing a computer such as the shelf label estimation device 10 to execute the estimation method.

Each program described in each example embodiment is recorded in a computer-readable recording medium such as an HDD, an SSD, a flexible disk, an optical disc, a magneto-optical disk, or a USB memory. Each program is read from the recording medium by the computer to be executed. Each program may be distributed via the communication network NT.

The function of each component of the shelf label estimation device 10 described above may be implemented by dedicated hardware such as a computer. Alternatively, each component may be implemented by software. Alternatively, each component may be implemented by a combination of hardware and software.

While the present disclosure has been particularly shown and described with reference to example embodiments thereof, the present disclosure is not limited to these example embodiments. The configurations and details of the present disclosure may include example embodiments to which various changes that can be grasped by those skilled in the art within the scope of the present disclosure are applied. The present disclosure may include example embodiments in which the matters described in the present specification are appropriately combined or replaced, as necessary. For example, the matters described with a specific example embodiment can be applied to other example embodiments as long as no contradiction occurs. For example, although a plurality of operations is described in order in the form of a flowchart, the described order does not limit the order in which the plurality of operations is executed. Therefore, when each example embodiment is carried out, the order of the plurality of operations can be changed within a range that does not interfere with the content.

Some or all of the example embodiments described above may also be described as Supplementary Notes below. However, some or all of the example embodiments described above are not limited to the following.

### Supplementary Note 1

A shelf label estimation device including:
a second extraction unit for extracting basic information of the shelf label for each region sandwiched by the extracted boundary lines; and
a first extraction unit for extracting boundary lines of the shelf label for each of the recognized shelf label candidates;
a recognition unit for performing object recognition of shelf label candidates from an image in which an article shelf is captured;
an estimation unit for estimating a single shelf label region for each of the regions by using a weighted average score of an extraction result of the basic information of the shelf label.

### Supplementary Note 2

The shelf label estimation device according to Supplementary Note 1, in which the estimation unit deletes at least one of boundary lines sandwiching the region when it is estimated that the region is not a single shelf label region by using the weighted average score.

### Supplementary Note 3

The shelf label estimation device according to Supplementary Note 1 or 2, in which the estimation unit estimates, for each of the regions, that the region is a single shelf label region when the weighted average score is equal to or more than a first threshold.

### Supplementary Note 4

The shelf label estimation device according to any one of Supplementary Notes 1 to 3, in which the estimation unit estimates, for each of the regions, whether the region is a single shelf label region or the region includes a plurality of shelf label regions by using the weighted average score.

### Supplementary Note 5

The shelf label estimation device according to Supplementary Note 4, further including an output unit for giving a notification in a case where it is estimated that the region includes a plurality of shelf label regions.

### Supplementary Note 6

The shelf label estimation device according to Supplementary Note 4, in which the estimation unit estimates, for each of the regions, that the region is a single shelf label region when the weighted average score is equal to or more than a first threshold and less than a second threshold, and estimates that the region includes a plurality of shelf label regions when the weighted average score is equal to or more than the second threshold.

### Supplementary Note 7

The shelf label estimation device according to any one of Supplementary Notes 1 to 6, in which the basic information of the shelf label includes a price, an article name, and a code.

### Supplementary Note 8

The shelf label estimation device according to Supplementary Note 7, in which the second extraction unit extracts the price and the article name by character recognition for each of the regions, and extracts the code by image recognition.

### Supplementary Note 9

The shelf label estimation device according to any one of Supplementary Notes 1 to 8, in which the first extraction unit extracts boundary lines of the shelf label by image recognition.

### Supplementary Note 10

A shelf label estimation method for causing a computer to execute processing of:
estimating a single shelf label region for each of the regions by using a weighted average score of an extraction result of the basic information of the shelf label. extracting basic information of the shelf label for each region sandwiched by the extracted boundary lines; and
extracting boundary lines of the shelf label for each of the recognized shelf label candidates;
performing object recognition of a shelf label candidate from an image in which an article shelf is captured;

### Supplementary Note 11

A program for causing a computer to execute processing of:
estimating a single shelf label region for each of the regions by using a weighted average score of an extraction result of the basic information of the shelf label. extracting basic information of the shelf label for each region sandwiched by the extracted boundary lines; and
extracting boundary lines of the shelf label for each of the recognized shelf label candidates;
performing object recognition of shelf label candidates from an image in which an article shelf is captured;

### Supplementary Note 12

A non-transitory computer-readable recording medium having stored therein a program for causing a computer to execute processing of:
estimating a single shelf label region for each of the regions by using a weighted average score of an extraction result of the basic information of the shelf label.
extracting basic information of the shelf label for each region sandwiched by the extracted boundary lines; and
performing object recognition of shelf label candidates from an image in which an article shelf is captured;
extracting boundary lines of the shelf label for each of the recognized shelf label candidates;

Some or all of the configurations described in Supplementary Notes 2 to 9 dependent on the above-described Supplementary Note 1 can also be dependent on Supplementary Notes 7, 8, and 9 with a dependency relationship similar to that of Supplementary Notes 2 to 9. Furthermore, not only Supplementary Notes 1, 10, 11, and 12 but also various types of hardware and software, and various recording unit for recording software or systems can be similarly dependent on some or all of the configurations described as the supplementary notes without departing from the above-described example embodiments.

According to the present disclosure, it is possible to improve estimation accuracy of a shelf label region.

1. A shelf label estimation device comprising:
at least one memory configured to store instructions; and
at least one processor configured to execute the instructions to:
perform object recognition of shelf label candidates from an image in which an article shelf is captured;
extract boundary lines of the shelf label for each of the recognized shelf label candidates;
extract basic information of the shelf label for each region sandwiched by the boundary lines; and
estimate a single shelf label region for each of the regions by using a weighted average score of an extraction result of the basic information of the shelf label.

2. The shelf label estimation device according to claim 1, wherein the at least one processor is further configured to execute the instructions to:
delete at least one of boundary lines sandwiching the region when it is estimated that the region is not a single shelf label region by using the weighted average score.

3. The shelf label estimation device according to claim 1, wherein the at least one processor is further configured to execute the instructions to: estimate, for each of the regions, that the region is a single shelf label region when the weighted average score is equal to or more than a first threshold.

4. The shelf label estimation device according to claim 1, wherein the at least one processor is further configured to execute the instructions to: estimate, for each of the regions, whether the region is a single shelf label region or the region includes a plurality of shelf label regions by using the weighted average score.

5. The shelf label estimation device according to claim 4, wherein the at least one processor is further configured to execute the instructions to: give a notification in a case where it is estimated that the region includes a plurality of shelf label regions.

6. The shelf label estimation device according to claim 4, wherein the at least one processor is further configured to execute the instructions to: estimate, for each of the regions, that the region is a single shelf label region when the weighted average score is equal to or more than a first threshold and less than a second threshold, and estimate that the region includes a plurality of shelf label regions when the weighted average score is equal to or more than the second threshold.

7. The shelf label estimation device according to claim 1, wherein the basic information of the shelf label includes a price, an article name, and a code.

8. The shelf label estimation device according to claim 1, wherein the at least one processor is further configured to execute the instructions to: extract boundary lines of the shelf label by image recognition.

9. A shelf label estimation method for causing a computer to execute processing of:
performing object recognition of shelf label candidates from an image in which an article shelf is captured;
extracting boundary lines of the shelf label for each of the recognized shelf label candidates;
extracting basic information of the shelf label for each region sandwiched by the extracted boundary lines; and
estimating a single shelf label region for each of the regions by using a weighted average score of an extraction result of the basic information of the shelf label.

10. A non-transitory computer-readable recording medium having stored therein a program for causing a computer to execute processing of:
performing object recognition of shelf label candidates from an image in which an article shelf is captured;
extracting boundary lines of the shelf label for each of the recognized shelf label candidates;
extracting basic information of the shelf label for each region sandwiched by the extracted boundary lines; and
estimating a single shelf label region for each of the regions by using a weighted average score of an extraction result of the basic information of the shelf label.
